(19) United States
(12) Patent Application Publication
(10) Pub. No.: US 2011/0228539 A1
(43) Pub. Date: Sep. 22, 2011

(54) OUTDOOR ILLUMINATING APPARATUS

(76) Inventor: Jen-Shyan Chen, Taiwan (CN)

(21) Appl. No.: 12/992,211

(22) PCT Filed: Aug. 20, 2009
(86) PCT No.: PCT/CN09/00956

§ 371 Date: Nov. 11, 2010

(51) Int. Cl. F21V 29/00

(52) U.S. Cl. 362/294; 362/373

(57) ABSTRACT

The invention provides an outdoor illuminating apparatus which includes a housing, a heat-conducting device, a light-emitting device, and an adaptor. The housing includes a space. The heat-conducting device is disposed in the space and includes a flat portion and a touching portion. The touching portion touches the housing. The light-emitting device is disposed on the flat portion and includes at least one light-emitting chip. The adaptor is engaged to the housing and includes a passage. Therein a light-guiding member could be engaged to the passage and be sealed therewith for guiding light emitted by the light-emitting chip. The housing can be assembled with a tubular body, a first cover, and a second cover, so as to form the space sealed substantially. The tubular body can be formed in one piece and a plurality of fins can be formed thereon at the same time to enhance heat-dissipating efficiency.

### BACKGROUND OF THE INVENTION

1. Field of the Invention

The present invention relates to an outdoor illuminating apparatus, and more particularly, relates to an outdoor illuminating apparatus with a light-emitting chip.

2. Description of the Prior Art

With the development of semi-conductor light emitting devices, a light-emitting diode (LED) which has several advantages, such as power save, seismic resistance, quick reaction, and so on, becomes a new light source. Therefore, LEDs are widely used as indicator lights on electronic devices, and the use of LEDs as light source of illumination products become a trend. In order to raise illumination, high-power LEDs are used as light source in the illumination products; however, these products have problems about heat dissipation.

So far, heat-dissipating modules of illumination products which contact with the LEDs are always exposed in order to dissipate heat efficiently, and the wires of the LEDs are also exposed thereby. Although there are no problems to use this kind of illumination products indoors, there might be some problems generated outdoors. For instance, the exposed wire is possible to short-circuit because of rain. Besides, if there is a casing covering the whole illuminator for preventing rain from affecting the wires, the heat-dissipating efficiency lowers thereby.

Therefore, it is necessary to provide an outdoor illuminating apparatus that can prevent rain from damaging the circuit and still has desired heat-dissipating efficiency for solving the above mentioned problems.

### SUMMARY OF THE INVENTION

Accordingly, a scope of the present invention is to provide an outdoor illuminating apparatus with a light-emitting chip, which is waterproof and has desired heat-dissipating efficiency.

The outdoor illuminating apparatus of the invention includes a housing, a heat-conducting device, and a light-emitting device. The housing includes a space. The heat-conducting device disposed in the space and includes a flat portion and a touching portion which touches the housing. The light-emitting device includes a substrate, a mount, and at least one light-emitting chip. The substrate includes a first sunken portion and a second sunken portion communicating with the first sunken portion. The mount touches the flat portion and is joined to the second sunken portion. Moreover, the at least one light-emitting chip is disposed on the mount. An adaptor is engaged to the housing and includes a passage. Therein light emitted by the at least one light-emitting chip passes through out of the housing. When the heat-conducting device includes a heat pipe, the touching portion could be at the heat pipe and the flat portion could be at an end of the heat pipe. The heat generated in operation by the light-emitting device is transferred to the housing through the light-conducting device and then dissipated from the housing. Because the heat could be dissipated from the housing to contact the air outside and the heat dissipation area of the housing is increasable, the outdoor illuminating apparatus of the invention can solve the problem of poor heat-dissipating efficiency due to a heat-dissipating module disposed inside the external housing.

There are several fins formed on the housing of the outdoor illuminating apparatus for raising the heat-dissipating efficiency. Further, the fins are disposed opposite to the touching portion of the heat-conducting device. In other words, the surface of the housing that the touching portion touches is opposite to the surface of the housing where the fins are formed for dissipating heat rapidly. Additionally, in order to adding the contact area between the touching portion of the heat-conducting device and the housing, there could be a sunken portion formed on the housing and the touching portion is disposed on the sunken portion. It could be additional to use a press plate to press the heat-conducting device so that the touching portion is forced to touch the housing. For example, if the heat-conducting device includes a heat pipe where the touching portion is, then the sunken portion is a fillister. The press plate could be pressed by the heat pipe directly so that the touching portion can contact the fillister tightly to increase the heat-conducting efficiency between the heat pipe and the housing.

The housing of the outdoor illuminating apparatus includes a tubular body, a first cover, and a second cover. The tubular body includes a first end and a second end. The first cover is engaged to the first end and the second cover is engaged to the second end for forming the space. Further, the first cover could be engaged to the tubular body by a seal ring. Additionally, there could be a fillister formed on the first cover or the tubular body and the seal ring is disposed in the fillister. By doing so, the seal ring can be used for sealing only, unnecessary to bear the structural force of the first cover or the tubular body. With the fillister, service life of the seal ring is extended and the stability of engagement between the first cover and the tubular body is rising. Similarly, the second cover is also engaged to the tubular body by a seal ring and thereby the space is sealed substantially for preventing rain or water vapor from affecting the electronic devices inside the housing (i.e. the space).

Moreover, the first cover could include a flat plate where a hole is formed. The adaptor is engaged to the flat plate through the hole. The adaptor could include a cylinder which is tightly fitted with the hole. An outer thread is formed on the cylinder and the cylinder is directly screwed into the hole like a self-tapping screw. Or there is an inner thread formed on the hole, and then the cylinder could be screwed into the hole easily due to the matching of the threads. This kind of design is useful for replacing the adaptor, and more particularly, useful for replacing the adaptor with an attachment lens or changing the diameter of the passage of the adaptor. Additionally, the heat-conducting device includes a supporting portion engaged to the first cover and the substrate of the light-emitting device is mounted on the supporting portion. By doing so, the light emitted by the light-emitting chip could still be transmitted through the adaptor accurately even in a vibration situation.

The outdoor illuminating apparatus of the invention further includes a light-guiding member able to be engaged to the passage and sealed therewith for guiding light emitted by the light-emitting chip. Thereby, the light is guided into the light-guiding member and then transmitted out from the surface of the light-guiding member for spreading. For example, there is a cylindrical light-guiding member and two outdoor illuminating apparatuses of the invention are engaged to the two ends of the light-guiding member respectively. Light emitted by the two outdoor illuminating apparatus could be transmitted uniformly out from the cylindrical surface of the light-guiding member, like a fluorescent lamp. Additionally, the shape of the light-guiding is not limited to a single cylinder and it could be other geometric figures.

The outdoor illuminating apparatus further includes a circuit module disposed in the space and electrically connected to the light-emitting device. A slide could be formed on the inner wall of the housing of the outdoor illuminating apparatus and a side of a circuit board of the circuit module is disposed on the slide. The design of the slide is conducive to the replacement of the circuit module. The outdoor illuminating apparatus of the invention further includes a partition plate disposed in the space to separate the space into a first sub-space and a second sub-space, therein the heat-conducting device is disposed in the first sub-space, and the circuit board is disposed in the second sub-space. By doing so, the influence of heat generated in operation by the light-emitting device being transferred from the first sub-space to the second sub-space on the operation of the circuit board could be reduced. Additionally, another slide could also on the inner wall of the housing and a side of the partition plate is disposed on the other slide. It is useful for installing the partition plate.

Additionally, the housing includes a waterproof passage and a power cord which could pass through the waterproof passage to electrically power the light-emitting device. Or the housing could include a waterproof connector and an external power supply through the waterproof connector electrically powering the light-emitting device or charging a built-in capacitor inside the outdoor illuminating apparatus for raising mobility of the outdoor illuminating apparatus.

The outdoor illuminating apparatus further includes a mounting bracket, and the housing is slidably disposed on the mounting bracket. Thus the outdoor illuminating apparatus is designed to be separable. The user can fix the mounting bracket anywhere and dispose the housing on it. By doing so, the housing could be separated from the mounting bracket by request and the flexibility of installation of the apparatus is raised. Additionally, the housing and the mounting bracket are engaged to by the method of dovetail join for raising the stability of the engagement. In this case, the engagement by the method of dovetail join means that the mounting bracket and the housing include a dovetail groove and a dovetail slider (or a slider and a groove) respectively and the dovetail slider is slidably disposed in the dovetail groove.

To sum up, the housing of the outdoor illuminating apparatus of the invention is used to dissipate heat and prevent rain from permeating into the apparatus. By the housing, the heat-dissipation efficiency of the outdoor illuminating apparatus of the invention becomes satisfactory and the above-mentioned problem is solved thereby. Further, there is a plurality of fins formed on the housing to enhance heat dissipation and the shapes of the fins are not limited. Additionally, the outdoor illuminating apparatus could be designed to be separable to raise the installation flexibility, and the dovetail join is taken to improve the engagement stability.

The advantage and spirit of the invention may be understood by the following recitations together with the appended drawings.

### BRIEF DESCRIPTION OF THE APPENDED DRAWINGS

FIG. 1 illustrates an outdoor illuminating apparatus according to a preferred embodiment of the invention.

FIG. 2 illustrates a cross section along plane P in FIG. 1.

FIG. 3 illustrates a cross section of a light-emitting device.

FIG. 4 illustrates a cross section of an outdoor illuminating apparatus according to an embodiment of the invention.

FIG. 5 illustrates an enlarged drawing of the circle X in FIG. 2.

FIG. 6 illustrates a cross section of an outdoor illuminating apparatus according to another embodiment of the invention.

FIG. 7 illustrates a diagram of a housing being slidably engaged to a mounting bracket of an outdoor illuminating apparatus.

FIG. 8 illustrates a breakdown drawing of an outdoor illuminating apparatus according to another preferred embodiment of the invention.

FIG. 9 illustrates a partial cross section of the outdoor illuminating apparatus in FIG. 8.

### DETAILED DESCRIPTION OF THE INVENTION

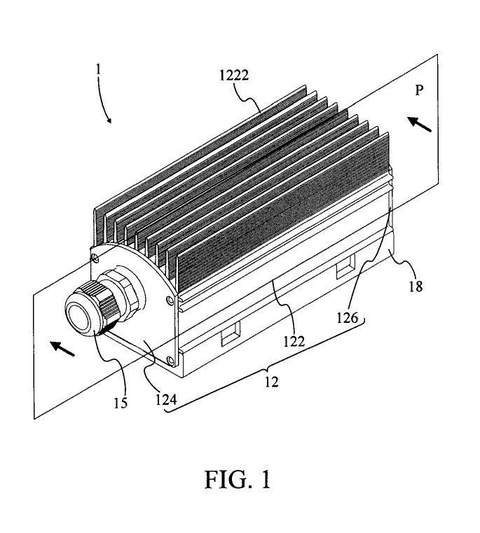

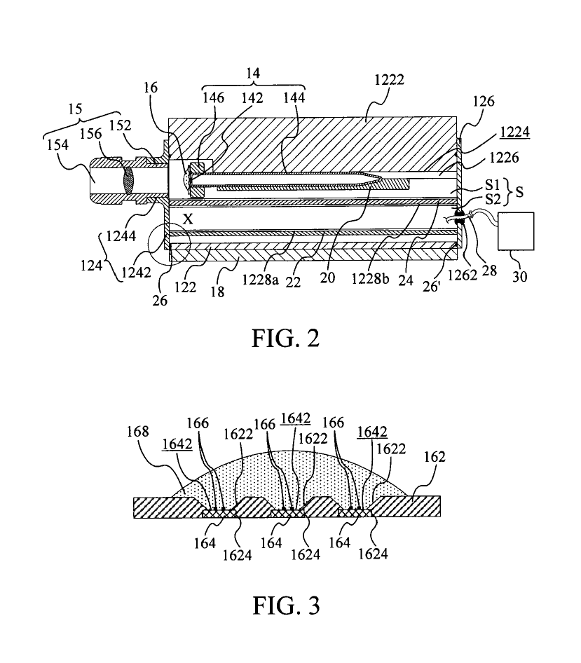

Please refer to FIG. 1 and FIG. 2. FIG. 1 illustrates an outdoor illuminating apparatus 1 according to a preferred embodiment of the invention. FIG. 2 illustrates a cross section along plane P in FIG. 1. The outdoor illuminating apparatus 1 includes a housing 12, a heat-conducting device 14, an adaptor 15, a light-emitting device 16, and a mounting bracket 18. The housing 12 is assembled with a tubular body 122, a front cover 124, and a rear cover 126. A plurality of fins 1222 are formed on the tubular body 122, and the shape of each fin is like a wave. The front cover 124 and the rear cover 126 are engaged to a front end and a back end of the tubular body 122 respectively to form a space S where the heat-conducting device 14 and the light-emitting device 16 are both disposed.

According to the preferred embodiment, the heat-conducting device 14 mainly consists of a heat pipe including a flat portion 142, a touching portion 144, and a supporting portion 146. The flat portion 142 is at an end of the heat pipe, and the supporting portion 146 is at the side of the end and surrounds the flat portion 142. A fillister 1223 is formed on the inner surface 1224 of the tubular body 122, the touching portion 144 of the heat-conducting device 14 is disposed in the fillister 1226, and a press plate 20 presses the touching portion 144 to be forced to contact the fillister 1226 tightly for rising the heat-conducting efficiency between the touching portion 144 and the tubular body 122. Additionally, the inner surface 1224 is opposite to the external surfaces of the tubular body 122, where the fins 1222 are formed on. Thereby the heat transferred to the fillister 1226 could be rapidly transferred to the fins 1222 for rapidly dissipating.

Please refer to FIG. 3. FIG. 3 illustrates a cross section of the light-emitting device 16. The light-emitting device 16 includes a substrate 162, three mounts 164, several light-emitting chips 166, and sealant 168. The substrate 162 could be a silicon substrate, a ceramic substrate or a circuit board. The mount 164 could be a silicon mount, a ceramic mount or a metallic mount, and the light-emitting chip 166 could be a light-emitting diode or a laser diode. The sorts of the light-emitting chips could be different and are not limited to be identical. As for the colors of the light emitted by the chips 166, they are not limited to be identical either. The substrate 162 includes three first sunken portions 1622 and three second sunken portions 1624 communicating to the first sunken portions 1622. Each mount 1622 touches the flat portion 142 of the heat-conducting device 14 and is joined to one of the second sunken portions 1624 to form a mounting chip area 1642 where the light-emitting chips 166 are disposed. If the mount 1622 is a silicon mount or a sapphire mount, the light-emitting chips 166 could be formed on it directly instead of mounting the chips 166 afterwards. The light-emitting chips 166 are also electrically connected to the electrodes (not shown in figure) formed on the substrate 162. The sealant 168 is used to seal the light-emitting chips 166. The substrate 162 is mounted on the supporting portion 146 of the heat-conducting device 14 so that the mount 164 could touch the flat portion 142 of the heat-conducting device 14 more tightly. Thereby the heat generated by the light-emitting chips 164 could be conducted through the mount 164 and the flat portion 142 to the heat-conducting device 14 rapidly.

Remarkably, the light-emitting device 16 could include a lens for modulating the direction of the propagation of the light emitted by the light-emitting chip 166. The lens is disposed above the sealant 168 or is formed together with the sealant 168. For example, the sealant 168 is formed with the shape of the lens. Therefore only the sealant is marked in figure but in fact we should treat the area as the combination of lens and sealant or single sealant.

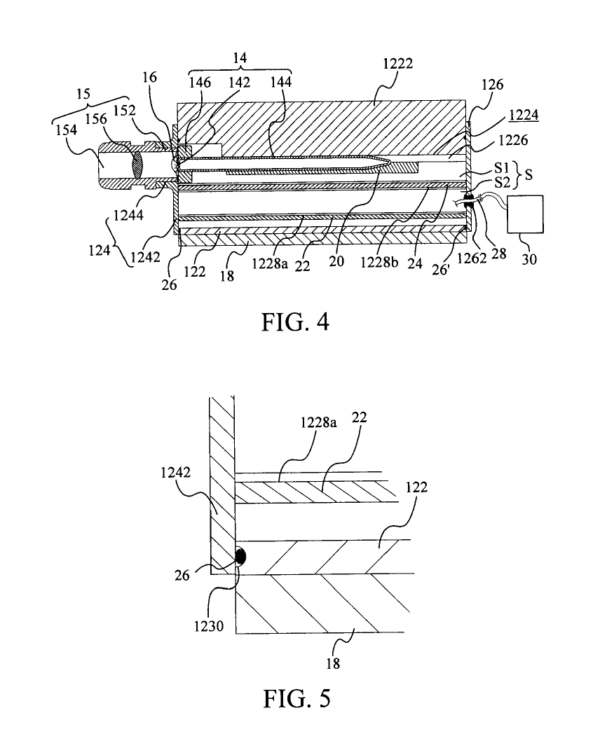

Please refer back to FIG. 2. The front cover 124 of the housing 12 mainly consists of a flat plate 1242 and a hole 1244 formed by extruding from the middle of the flat plate 1242. The adaptor 15 includes a cylinder 152 and is engaged to the hole 1244 by the cylinder 152. The engagement could be made by tightly inserting the cylinder 152 into the hole 1244. Alternatively, an outer thread is formed on the cylinder 152, a matching inner thread is formed on the hole 1244, and then the cylinder 152 could be screwed into the hole 1244. Or a self-tapping thread is formed on the cylinder 152 merely and then the cylinder 152 is screwed into the hole 1244. The shape of the external part of the adaptor 15 is hexagonal prism, which is easy to install. The adaptor 15 further includes a passage formed by a hole 154. The passage is used to communicate the internal of tubular body 122 with the external of the outdoor illuminating apparatus 1. Therefore the adaptor 15 is transparent. The light-emitting device 16 is disposed right opposite to the hole 154 so that the light emitted by light-emitting device 16 passes through the hole 154. At least one lens 156 or filters could be disposed in the hole 154 for modulating the light emitted by light-emitting device 16 again. Additionally, in order to raise the illumination of the outdoor illuminating apparatus 1 of the invention, the inner wall of the hole 154 could be coated with a reflective material for improving reflection. Similarly, in an embodiment, the supporting portion 146 of the heat-conducting device 14 is close to the front cover 124 for preventing the light emitted by the light-emitting device 16 from scattering into the tubular body 122, so as to raise the light flux. Additionally, in another embodiment, the supporting portion 146 of the heat-conducting device 14 is directly engaged to the front cover 124. By doing so, the light emitted by the light-emitting chip 166 could pass through the hole 154 of the adaptor 15 accurately, even in a vibration situation, as shown in FIG. 4.

According to the preferred embodiment, two pairs of slides—1228a and 1228b are formed on the inner wall of the tubular body 122 and each pair of the slides (1228a and 1228b) is disposed oppositely. Therefore only one pair of the slides (1228a and 1228b) is illustrated in FIG. 2. A circuit board 22 which could be slid into the slide 1228a includes related controlling units and circuits (not shown in figure) thereon. The circuit board 22 is electrically connected to the light-emitting device 16 for controlling the light-emitting device 16 to emit light. Additionally, a partition plate 24 could be slid into the slide 1228b to separate the space S into two sub-spaces—S1 and S2. Therein the heat-conducting device 14 is disposed in the sub-space S1 and the circuit board 22 is disposed in the sub-space S2. With the partition plate 24, it can prevent the heat generated by the light-emitting device 16 from being transferred to the sub-space S2, so as to affect the operation of the circuit board 22. When the partition plate 24 is made of heat insulation material, most of heat is transferred to the fins through the fillister 1226 and then be dissipated.

Please refer to FIG. 5. FIG. 5 illustrates an enlarged drawing of the circle X in FIG. 2. In order to seal the space S well, when the front 124 and the tubular body 122 are engaged, a seal ring 26 is disposed between them for sealing the space S. At the same time, the seal ring 26 could be disposed in a fillister 1230 formed on the tubular body 122 for preventing from bearing excessive structural force. Additionally, the fillister 1230 could also be formed on the front cover 124 or symmetrically on both the front cover 124 and the tubular body 122. Similarly, the engagement of the rear cover 126 and the tubular body 122 could be made with a seal ring 26′ disposed in a fillister (not shown in figure), as shown in FIG. 2.

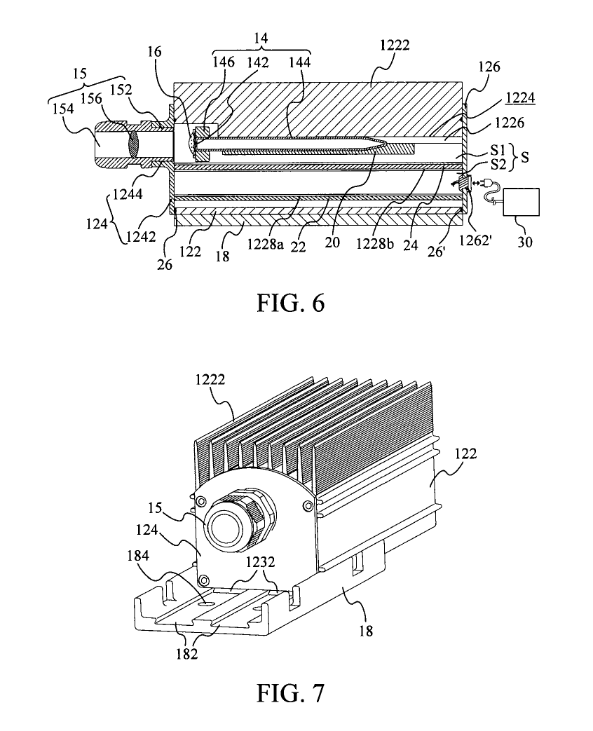

Please refer to FIG. 2. The rear cover 126 includes a waterproof passage 1262. A hole is formed on the rear cover 126 and then a rubber ring with an elastic hole is disposed in the hole to form the passage 1262. A power cord 28 could pass through the elastic hole and an external power supply 30 electrically powers the circuit board 22 via the power cord 28. In another embodiment, the above-mentioned waterproof passage 1262 could be replaced by a waterproof connector 1262′. An end of the waterproof connector 1262′ is electrically connected to the circuit board 22 disposed in the space S and the other end of the waterproof connector 1262′ provides a connecting interface which is pluggable and extractable to be electrically connected to the external power supply 30, as shown in FIG. 6. By doing so, the external power supply 30 could electrically power the circuit board 22 or charge a built-in capacitor inside the outdoor illuminating apparatus 1 for raising mobility of the outdoor illuminating apparatus 1.

Please refer to FIG. 1 and FIG. 7. FIG. 7 illustrates a diagram of a housing 12 of an outdoor illuminating apparatus 1 slidably engaged to the mounting bracket 18. The mounting bracket 18 includes a dovetail groove 182, and a tubular body 122 includes a dovetail slider 1232 correspondingly. The dovetail slider 1232 is slidably disposed in the dovetail groove 182. By doing so, the housing 12 is slidably and stably disposed on the mounting bracket 18 by request. Of course, it can use different types of slides to engage the housing 12 and the mounting bracket 18. In practical application, a plurality of mounting holes 184 could be formed on the mounting bracket 18 for mounting the mounting bracket 18 on some fixture. The housing 12 could be disposed on or separated from the mounting bracket 18 by request. Thereby, the outdoor illuminating apparatus 1 is easy to install. It is remarkable that the mounting holes 184 are not limited to be formed at the bottom of the mounting bracket 18; they could also be formed on the side wall of the mounting bracket 18. Or the mounting bracket 18 could include an interface structure connecting with the fixture for mounting the mounting bracket 18 on the fixture.

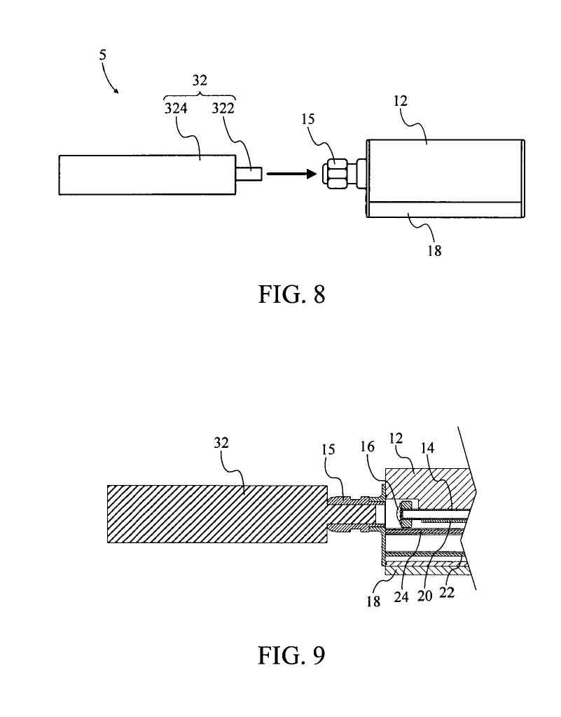

Please refer to FIG. 8. FIG. 8 illustrates a breakdown drawing of the outdoor illuminating apparatus 5 according to another preferred embodiment of the invention. In order to simplify the drawing, FIG. 8 is briefly sketched. The difference between this embodiment and the last embodiment is that the outdoor illuminating apparatus 5 further includes a light-emitting guiding member 32 engaged to the hole 154 of the adaptor 15 and sealed therewith for guiding the light emitted by the light-emitting device 16. It is remarkable that the FIG. 8 illustrates a separation state of the light-emitting guiding member 32. The arrow in FIG. 8 points out that the direction of the light-emitting guiding member 32 is inserted into the hole 154. The light-emitting guiding member 32 includes an inserting portion 322 and a light-emitting portion 324. The inserting portion 322 is inserted into the hole 154 tightly or inserted into the hole 154 after coating with waterproof oil thereon so as to achieve a sealed join. Of course, at least one O-ring could be disposed on the hole 154 and the inserting part 322 could pass through the O-ring for being sealed therewith.

After the light emitted by the light-emitting device 16 is transmitted through the inserting portion 322 into the light-emitting guiding member 32, it is transmitted to the light-emitting portion 324. The performance of the light-emitting portion 324 is similar to a fluorescent lamp. It is remarkable that in this preferred embodiment, the light emitted by the light-emitting device 16 is transmitted from the light-emitting portion 324 of the light-emitting guiding member 32 finally. Therefore a lens (as the lens 156 in FIG. 2) is not disposed in the hole 154 of the adaptor 15, as shown in FIG. 9. If the lens 156 is disposed in the hole 154, which is also helpful to uniform the light incident to the inserting portion 322. Additionally, the light-emitting guiding member 32 is not limited to be a solid structure; it could be a hollow structure, a multi-layer structure or a composite material structure.

Additionally, there is only one incident for light to enter the light-emitting guiding member 32, and the light-emitting portion 324 is not easy to emit light uniformly. Therefore another inserting portion is formed on the other end of the light-emitting guiding member 32 and the inserting portion is inserted into an adaptor of the other outdoor illuminating apparatus. In other words, the light-emitting portion 324 could emit light more uniformly when the light is incident to both ends of the light-emitting guiding member 32. In practical application, the shape of light-emitting guiding member 32 is not limited to cylinder; it could be different geometric figures or has several ends/inserting portions. The light-emitting guiding member could also be engaged to several outdoor illuminating apparatuses by the different illumination request or the visual request. Additionally, the outer diameter of the inserting portion 322 is different from that of the light-emitting portion 324, as shown in FIG. 8; however, it is not limited to this. The diameter of the inserting portion 322 could be equal to the diameter of the light-emitting portion 324, which is good for making the light-emitting guiding member 32.

To sum up, the housing of the outdoor illuminating apparatus of the invention is used to dissipate heat and prevent rain from permeating into the apparatus. With the housing, the heat-dissipating efficiency of the outdoor illuminating apparatus of the invention become satisfactory, and the above-mentioned problem is solved thereby. Furthermore, there is a plurality of fins formed on the housing to enhance heat dissipation, and the shapes of the fins are not limited because there is not any casing covering beyond. Additionally, the outdoor illuminating apparatus could be designed to be separable and to be engaged by the method of dovetail join. Therefore the apparatus is easy to install and the stability of engagement rises.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An outdoor illuminating apparatus comprising:
a housing comprising a space;
a heat-conducting device disposed in the space and comprising a flat portion and a touching portion which touches the housing;
a light-emitting device comprising a substrate, a mount, and at least one light-emitting chip, the substrate comprising a first sunken portion and a second sunken portion communicating with the first sunken portion, the mount touching the flat portion and being joined to the second sunken portion, the at least one light-emitting chip being disposed on the mount; and
an adaptor engaged to the housing and comprising a passage, wherein light emitted by the at least one light-emitting chip passes through the passage out of the housing.

2. The outdoor illuminating apparatus of claim 1, further comprising a light-guiding member engaged to the passage and sealed therewith for guiding the light emitted by the at least one light-emitting chip.

3. The outdoor illuminating apparatus of claim 1, wherein the hosing comprises a tubular body, a first cover, and a second cover, the tubular comprises a first end and a second end, the first cover is engaged to the first end, and the second cover is engaged to the second end, so as to form the space.

4. The outdoor illuminating apparatus of claim 3, wherein the first cover is engaged to the tubular body by a seal ring.

5. The outdoor illuminating apparatus of claim 4, wherein a fillister is formed on the first cover or the tubular body, and the seal ring is disposed in the fillister.

6. The outdoor illuminating apparatus of claim 3, wherein the first cover comprises a flat plate and a hole formed on the flat plate, and the adaptor is engaged to the flat plate through the hole.

7. The outdoor illuminating apparatus of claim 6, wherein a thread is formed on the adaptor, and the adaptor is screwed into the hole by the thread.

8. The outdoor illuminating apparatus of claim 6, wherein the heat-conducting device comprises a supporting portion engaged to the first cover, and the substrate of the light-emitting device is disposed on the supporting portion.

9. (canceled)

10. (canceled)

11. The outdoor illuminating apparatus of claim 1, wherein the housing comprises a sunken portion and the touching portion of the heat-conducting device is disposed on the sunken portion.

12. The outdoor illuminating apparatus of claim 1, further comprising a press plate pressed on the heat-conducting device, the press plate pressing the heat-conducting device so that the touching portion is forced to touch the housing.

13. The outdoor illuminating apparatus of claim 1, wherein the heat-conducting device comprises a heat pipe, and the touching portion is on the heat pipe.

14. The outdoor illuminating apparatus of claim 1, wherein the heat-conducting device comprises a heat pipe, and the flat portion is at an end of the heat pipe.

15. The outdoor illuminating apparatus of claim 1, further comprising a circuit module disposed in the space and electrically connected to the light-emitting device.

16. The outdoor illuminating apparatus of claim 13, wherein the circuit module comprises a circuit board, the housing comprises a first slide, and a side of the circuit board is disposed on the slide.

17. The outdoor illuminating apparatus of claim 14, further comprising a partition plate disposed in the space to separate the space into a first sub-space and a second sub-space, wherein the heat-conducting device is disposed in the first sub-space, and the circuit board is disposed in the second sub-space.

18. The outdoor illuminating apparatus of claim 15, wherein the housing comprises a second slide and a side of the partition plate is disposed on the second slide.

19. The outdoor illuminating apparatus of claim 1, wherein the space is substantially sealed.

20. The outdoor illuminating apparatus of claim 1, wherein the housing comprises a waterproof passage and a power cord could pass through the waterproof passage to electrically power the light-emitting device.

21. The outdoor illuminating apparatus of claim 1, wherein the housing comprises a waterproof connector electrically connected to the light-emitting device, and an external power supply electrically powering the light-emitting device via the waterproof connector.

22. The outdoor illuminating apparatus of claim 1, furthering comprising a mounting bracket, wherein the housing is slidably disposed on the mounting bracket and the mounting bracket comprises a dovetail groove, the housing comprises a dovetail slider, and the dovetail slider is slidably disposed in the dovetail groove.

23. (canceled)
